(19) United States
(12) Patent Application Publication
(10) Pub. No.: US 2015/0012483 A1
(43) Pub. Date: Jan. 8, 2015

(54) OPEN DATABASE-BASED FAR-DISTANCE BICENTRIC ONLINE PROCESSING METHOD AND SYSTEM

(71) Applicant: Bank of Communications, Shanghai (CN)

(72) Inventors: Shihui ZHENG, Shanghai (CN); Zhujun SHI, Shanghai (CN)

(73) Assignee: Bank of Communications, Shanghai (CN)

(21) Appl. No.: 14/289,293

(22) Filed: May 28, 2014

(30) Foreign Application Priority Data
Jul. 3, 2013 (CN) 2013-10277455.3

(51) Int. Cl. G06F 17/30

(52) U.S. Cl. CPC G06F 17/30589
USPC 707/607

(57) ABSTRACT

An open database-based far-distance bicentric online processing method and system are disclosed. The method comprising: capturing a database access related information of an online transaction from an APP server; automatically recognizing update statements and query statements according to SQL statements in the database access related information and a type of a storage process; and directing the update statements and the query statements to database servers of a primary center and a backup center respectively for operation. The present invention routes the query statements to the backup center to realize an open system ultra-far-distance bicentric transaction processing, thereby breaking the limitation of the 30 km distance of the IBM GDPC and ORACLE Rac technologies, improving the processing capacity and usability of the production system, and sufficiently utilizing the resources of the backup centers in the same city.

### CROSS-REFERENCE TO RELATED APPLICATIONS

This application claims priority to Chinese Patent Application No. 201310277455.3, filed on Jul. 3, 2013, which is hereby incorporated by reference in its entirety.

### FIELD OF TECHNOLOGY

The present invention relates to an online transaction processing method and system, and particularly, to an open database-based far-distance bicentric online processing method and system.

### BACKGROUND OF THE INVENTION

According to the “Disaster Backup and Recovery Specification for Information System” issued by the China Banking Regulatory Commission, the sixth level of disaster backup specifies a zero data loss and a remote cluster support, and it is the highest level for disaster backup. That is to say, a bicentric operation environment is established in a same city, and the two centers operate services simultaneously to backup each other, so as to take over the transaction processing of the opposite party in real time when a disaster happens. However, the characteristic of the business processing of a commercial bank is a large-scale online transaction processing, and in order to ensure the integrity and consistency of the financial data, only a single database can be used for the centralized processing, and the transaction performance is degraded rapidly with the increase of the distance. Thus how to perform a far-distance bicentric financial transaction processing is a difficult problem for the international counterparts.

In year 2009, the far-distance bicentric operation processing of the mainframe system was realized in China, and obtained the China national invention patent licensing (“Mainframe-based Far-distance Bicentric Transaction Online Business Processing and System”, patent No. ZL200910200086.1) and the US patent licensing (“Mainframe-based Far-distance Bicentric Transaction Information Processing Method and System”, US patent No. U.S. Pat. No. 8,352,363 B2) in year 2012. The application of an open platform (UNIX) usually employs a three-layered structure of Web, APP and DB servers, wherein the Web and APP servers support a distributed processing, and realize multi-node deployment and load balance through a clustering technology. But the active-active function of the database system is limited by the delay of fiber optic transmission, and in the world there is no institution having a fiber optic running distance more than 30 km between two centers in a same city.

From an overall perspective of a bank, the above active-active mode is incomplete. Because once a disaster occurs, the front-end processing system of the open platform cannot work normally, and even if the core system is normal, the service also cannot be provided to the external. The active-active integration is a fmal state of city-wide bicentric active-active mode, and the key for a successful active-active open platform lies in the active-active mode of the database.

Currently, DB2 and Oracle are the databases most widely used in open platform. IBM proposed a city-wide database active-active scheme GDPC (the geographically dispersed DB2 pureScale cluster) in year 2012, but the research results of the IBM laboratory show that the response time of a transaction rapidly increases to be unbearable when the fiber optic distance between two centers is more than 30 km. Oracle also released the similar product (extended RAC), but it is officially suggested that the maximum distance should not exceed 32 km, otherwise a serious delay will occur.

### SUMMARY OF THE INVENTION

The embodiments of present invention provide an open database-based far-distance bicentric online processing method and system, so as to realize a far-distance bicentric transaction.

In order to achieve an object of embodiments of present invention, the embodiments of present invention provides an open database-based far-distance bicentric online processing method, comprising: capturing database access related information of an online transaction from an APP server; automatically recognizing update statements and query statements according to SQL statements in the database access related information and a type of a storage process; and directing the update statements and the query statements to database servers of a primary center and a backup center respectively for operation.

Any transaction can be decomposed into SQL statements, and is realized through combination and execution of different SQL statements, while the storage process is a packaging of a combination of certain SQL statements. Generally, as an interface for connecting the WAS to the database, a JDBC is responsible for establishing a physical connection from the WAS to the DB2, and transmitting the SQL statements or the packaged SQL statements (i.e., the storage process) to the database for processing. The embodiments of present invention uses this principle of the database to reconstruct the JDBC, to change the JDBC transmission path, to transmit the SQL statements or the storage process to a JDBC driving controller for separation, and then selecting a database object according to the result of the separation.

In one embodiment, before automatically recognizing the update statements and the query statements according to the SQL statements in the database access related information and the type of the storage process, the method further comprising: constituting a far-distance bicentric four-layered architecture F5->Web->APP->DB.

In one embodiment, automatically recognizing the update statements and the query statements according to the SQL statements in the database access related information and the type of the storage process comprises: dividing the database access related information into the update statements and the query statements according to the SQL statements and the storage process; generating a separating policy table of the storage process and a separating policy table of dynamic SQL, wherein the separating policy table of the storage process comprises updating-type storage process names, and the separating policy table of the dynamic SQL sets an initial word “select” of a SQL statement as a keyword.

In one embodiment, for the separating policy table of the storage process, if the updating-type storage process names include updated keyword statement or update statement contains a list of the stored procedure name, the database access related information is an update statement, otherwise it is a query statement.

In one embodiment, for the separating policy table of the dynamic SQL, if the initial word is “select” as the keyword, the database access related information is a query statement, otherwise it is an update statement.

In order to achieve an object of embodiments of present invention, the embodiments of present invention provides an open database-based far-distance bicentric online processing system, comprising: an information acquiring unit configured to capture database access related information of an online transaction from an APP server; an access information recognizing unit configured to automatically recognize update statements and query statements according to SQL statements in the database access related information and a type of a storage process; and a statement separating unit configured to direct the update statements and the query statements to database servers of a primary center and a backup center for operation, respectively.

In one embodiment, the system further comprises an architecture constituting unit configured to constitute a far-distance bicentric four-layered architecture F5->Web->APP->DB.

In one embodiment, the access information recognizing unit comprises: an access information classifying module configured to automatically recognize the update statements and the query statements according to the SQL statements in the database access related information and the type of the storage process; and a policy table generating module configured to generate a separating policy table of the storage process and a separating policy table of dynamic SQL, wherein the separating policy table of the storage process comprises updating-type storage process names, and the separating policy table of the dynamic SQL sets an initial word “select” of a SQL statement as a keyword.

In one embodiment, for the separating policy table of the storage process, if the updating-type storage process names include updated keyword statement or update statement contains a list of the stored procedure name, the database access related information is a update statement, otherwise it is a query statement.

In one embodiment, for the separating policy table of the dynamic SQL, if the initial word is “select” as the keyword, the database access related information is a query statement, otherwise it is a update statement.

The embodiments of the present invention have the following beneficial effects: by the embodiments of the present invention, the query statements are routed to the backup center to realize an open system ultra-far-distance (70 km) bicentric transaction processing, thereby breaking the limitation of the 30 km distance of the IBM GDPC and ORACLE Rac technologies, and in a case where one center is faulted, the service is taken over by the other center almost without interrupting the operation. Meanwhile, idle resources for backup in the backup center are changed as a part of the production. The active-active system meets the requirements of both the production and the disaster backup, and the resource utilization efficiency is greatly increased, thereby improving the processing capacity and usability of the production system. The embodiments of present invention is suitable for not only commercial banks, but also industries concerning large-scale online transaction processing, such as securities, futures, civil aviation, railway, etc.

### BRIEF DESCRIPTION OF THE DRAWINGS

In order to more clearly describe the technical solutions in the embodiments of the present invention or the prior art, the drawings to be used in the description of the embodiments or the prior art will be briefly introduced as follows. Obviously, the following drawings just illustrate some embodiments of the present invention, and a person skilled in the art can obtain other drawings from these drawings without paying any creative effort.

FIG. 1 is a flowchart of a far-distance bicentric online transaction processing according to an embodiment of the present invention;

FIG. 2 is a separating policy table of a storage process according to an embodiment of the present invention;

FIG. 3 is a separating policy table of a dynamic SQL according to an embodiment of the present invention;

FIG. 4 is a schematic diagram of a separating process according to an embodiment of the present invention;

FIG. 5 is a structural diagram of a far-distance bicentric information processing system according to an embodiment of the present invention; and

FIG. 6 is a structural diagram of an access information recognizing unit according to an embodiment of the present invention.

### DETAILED DESCRIPTION OF THE INVENTION

The technical solutions of the embodiments of the present invention will be clearly and completely described as follows with reference to the drawings. Obviously, the described embodiments are just a part of embodiments of the present invention rather than all the embodiments. Based on the embodiments of the present invention, any other embodiment obtained by a person skilled in the art without paying any creative effort shall fall within the protection scope of the present invention.

The embodiments of present invention allocate new processing partitions at the backup center 70 km away, to form a cluster system together with the system of the production center. Through a transaction separator developed by the applicant, the SQL query statement is routed in the JDBC layer to the backup center for operation, and other updating-type transactions are operated at the production center, thereby realizing a far-distance open-system bicentric operation without influencing the entire transaction performance. In addition, when a center is faulted, the transaction separator can automatically route all production transactions to another center for operation, thereby ensuring a high transaction usability.

### A First Embodiment

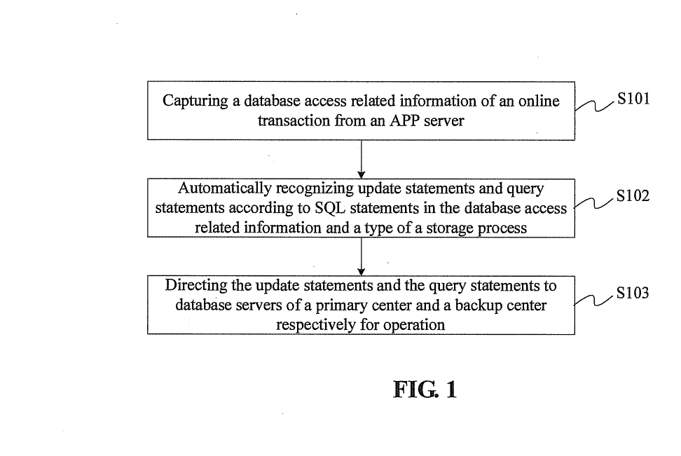

As illustrated in FIG. 1, the embodiment of the present invention provides an open database-based far-distance bicentric online processing method, comprising:

Step S101: capturing database access related information of an online transaction from an APP server.

Before step S101, a far-distance active-active operation architecture shall be established, and in the current open platform, a four-layered architecture of F5->Web->APP->DB is usually employed:
The F5 load balancer is used for the load balance from a Http request to a Web server;
The Web employs IBM HIS, and is used for the access of the Http request;
The Accelerate Parallel Processing (APP) employs IBM Websphere, and is used for the processing of application logics;
The DB employs IBM DB2, and is used for the data storage.

But none of the layers in the above four-layered architecture realizes the function of read/write separation.

In order to realize the function of separation, the present invention establishes a far-distance bicentric four-layered architecture F5->Web->APP->DB, which reconstructs the APP therein:
The F5 load balancer is used for the separation of the Web requests based on regions;
The Web server, is still used for the access of the Http request, but it only transmits the Http request to a fixed corresponding APP server;
The APP layer still employs IBM WebSphere middleware, but it employs the JDBC separator developed by the Bank of Communications of China to realize the read/write separation—the DML and the updating-type storage process are transmitted to the DB2 member of the primary center, while the DQL and the query-type storage process are transmitted to the DB2 member of the secondary center;
The DB layer is based on the IBM GDPC architecture, but it is a bran-new active-active disaster backup architecture suitable for online transaction processing formed through sufficient tests and optimizations based on the IBM GDPC architecture, rather than the standard GDPC architecture. The active-active function can only be realized by combining such architecture with the read/write separation technology.

The architecture has the following characteristics:

The production center has two DB2 members and two cluster caching facilities (CF), primary and secondary CFs. The CF is also called as PowerHA pureScale, which is a component of the DB2 pureScale cluster for coordinating the accesses to the shared data by the DB2 members in the cluster, and for ensuring the data consistency. The component may be divided into three modules: Group Bufferpool, Global lock manager and Shared Communication Area. And the component is implemented by three processes: ca-server, ca-mgmnt-lwd and ca-wdog. The backup center has one DB2 member and one cold backup CF, which constitute a DB data sharing group. This architecture mainly differs from the IBM GDPC architecture in the following three distinctions:
The primary and secondary CFs are both placed at the production center, which brings far better performance to a DML and the updating-type storage process only operated at the production center than the IBM GDPC architecture, and there is almost no influence on the query dynamic SQL and the query-type storage process only operated at the secondary center.
The numbers of hosts for the DB2 members and the CFs of the production center and the backup center need not to be consistent with each other, so that the extension is more flexible than the IBM GDPC architecture.
The backup center has a cold backup CF as a backup for the secondary CF of the production center, and it is only used at the time of a planned switching to ensure that the service will not be interrupted during the switching.

When an unplanned switching happens, the DB2 member of the backup center plays the roles of both the DB and the CF, and the role transition is performed by means of scripts, thus the flexible role transition breaks the limitation to the IBM GDPC software product.

Step S102: automatically recognizing update statements and query statements according to SQL statements in the database access related information and a type of a storage process.

In step S102, firstly, the database access related information is divided into the update statements and the query statements according to the SQL statements and the storage process. Next, a separating policy table of the storage process and a separating policy table of the dynamic SQL are generated, wherein the separating policy table of the storage process comprises updating-type storage process names, which can be provided with wildcards according to the naming criterion; and the separating policy table of the dynamic SQL sets the initial word “select” of the SQL statement as a keyword.

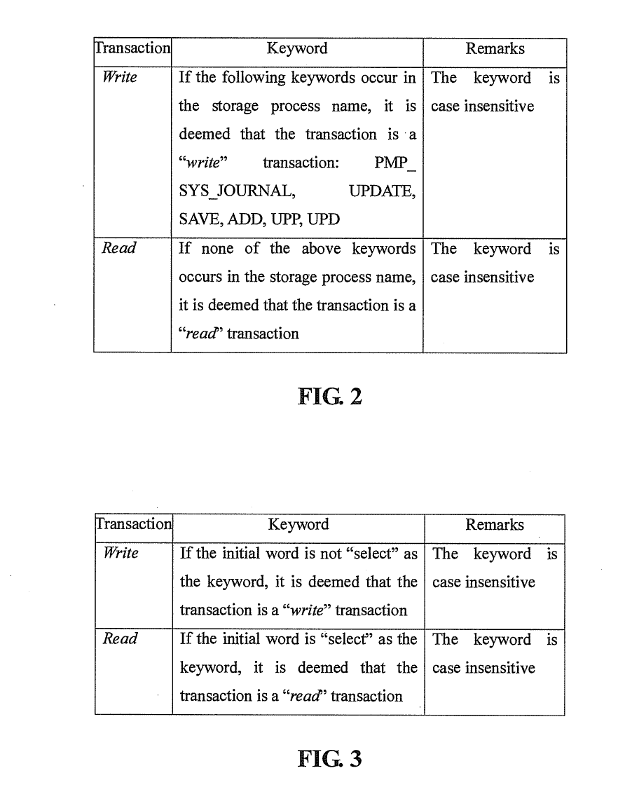

As illustrated in FIG. 2, for the separating policy table of the storage process, if the updating-type storage process names include PMP_SYS_JOURNAL, UPDATE, SAVE, ADD, UPP or UPD statement, the database access related information is an update statement, otherwise it is a query statement.

As illustrated in FIG. 3, for the separating policy table of the dynamic SQL, if the initial word is “select” as the keyword, the database access related information is a query statement, otherwise it is an update statement.

Step S103: respectively directing (read/write separation) the update statements and the query statements to database servers of the primary center and the backup center for operation, according to the separating policy table of the storage process and the separating policy table of the dynamic SQL in step S102.

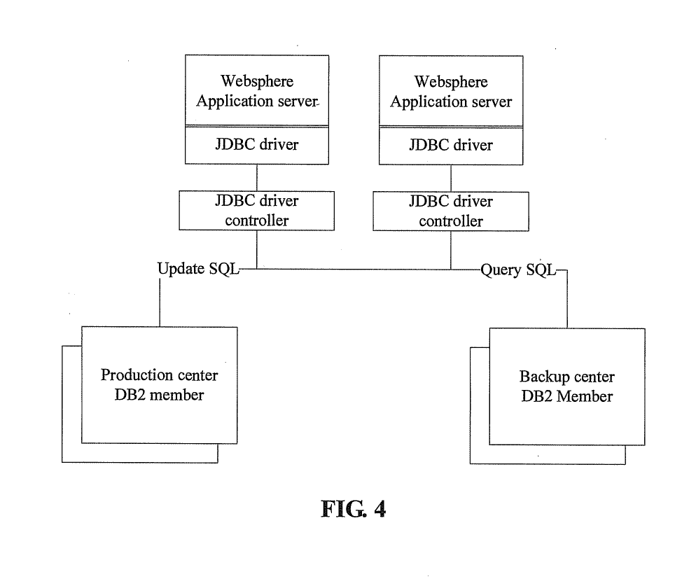

The technology for realizing read/write separation in the embodiments of the present invention takes the principle of not to modify the application, and the read/write separation is realized in the JDBC layer, including the following two parts:
A set of programs for the standard JDBC Driver interface: these programs in fact send the request to the JDBC Driver Controller (as illustrated in FIG. 4), rather than directly sending the request to the database. When a certain DB node is faulted, the transaction is automatically transferred to a DB node in normal state through an Auto Client Rerouter (ACR), so as to ensure the sustainability of the transaction.
A JDBC Driver Controller: it is an always running process, and also a control switch for the read/write separation of the transaction. It receives an SQL request from the JDBC Driver interface, judges the SQL content, forwards the request for SQL for updating and storage process for updating to the DB2 member of the primary center, and forwards the request for SQL for query and storage process for query to the DB2 member of the secondary center.

By the embodiments of the present invention, the query statements (the query statements are almost not influenced by the distance delay; the transaction response time of the backup center falls within an acceptable range by routing the query statements to the backup center in the same city for operation; meanwhile, a database lock occupied by the query statements is a shared lock, and it also does not influence the performance of the local transaction) is routed to the backup center to realize an open system ultra-far-distance (70 km) bicentric transaction processing, thereby breaking the limitation of the 30 km distance of the IBM GDPC and ORACLE Rac technologies, improving the processing capacity and usability of the production system, extending the selection range of the active-active system, sufficiently utilizing the resources of the remote center, and improving the high usability of the open system. The present invention is suitable for not only commercial banks, but also industries concerning large-scale online transaction processing, such as securities, futures, civil aviation, railway, etc.

After completing the read/write separation, the embodiments of the present invention need to perform drilling of planned and unplanned active-active switching through the scripts. The drilling of switching of the planned switching scripts and the planned return scripts, and the unplanned switching scripts and the unplanned return scripts are described as follows respectively through examples:

| Planned switching scripts: | |
|---|---|
| #change ZJ GPFS node to nonquorum | |
| #mmchnode -N <ZJ node id in GPFS> --nonquorum | |
| #ZJ node id in GPFS can get by command mmlscluster | |
| echo “change ZJ GPFS node to nonquorum” | |
| date | |
| mmchnode -N 1 --nonquorum | |
| #set secondary configure node in GPFS to null | |
| echo “change GPFS secondary configure node to null” | |
| date | |
| mmchcluster -s ” | |
| #close ZJ disks | |
| rgreq -o unlock db2_db2ipmps_0-rg | |
| rgreq -o unlock db2_db2ipmps_1-rg | |
| rgreq -o unlock db2_db2ipmps_2-rg | |
| echo “fallback finished” | |
| date | |
| Unplanned return scripts (6): | |
| #change ZJ GPFS node to quorum | |
| #mmchnode -N <ZJ node id in GPFS> --quorum | |
| #ZJ node id in GPFS can get by command mmlscluster | |
| echo “change ZJ GPFS node to quorum” | |
| date | |
| mmchnode -N 1 --quorum | |
| #let one of ZJ node be a secondary configure node in GPFS | |
| echo “set ZJ node to be GPFS secondary configure node” | |
| date | |
| mmchcluster -s DBPMPS01 | |
| #start ZJ disks | |
| echo “start ZJ disks” | |
| date | |
| mmchdisk db2fsl | start -d gpfslnsd |

mmchdisk gspmpsdb201 start -d gpfs2nsd
echo “finished”
date

The drillings of switching in the above examples illustrate that the active-active architecture of the embodiments of the present invention meet the active-active high usability standard, and well achieve the ultra-far-distance bicentric operation.

### A Second Embodiment

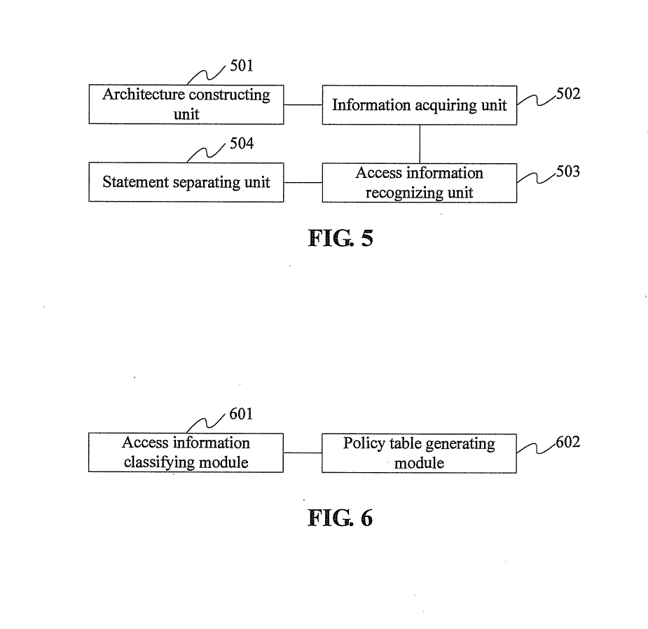

As illustrated in FIG. 5, the embodiment provides an open database-based far-distance bicentric online processing system, comprising: an architecture constructing unit 501, an information acquiring unit 502, an access information recognizing unit 503 and a statement separating unit 504.

The architecture constructing unit 501 is configured to construct a far-distance bicentric four-layered architecture F5->Web->APP->DB. The information acquiring unit 502 is configured to capture database access related information of an online transaction from an APP server. The far-distance bicentric four-layered architecture reconstructs the APP of the existing four-layered architecture as follows:
The F5 load balancer is used for the separation of the Web requests based on regions;
The Web server is still is used for the access of the Http request, but it only transmits the Http request to a fixed corresponding APP server;
The APP layer still employs IBM WebSphere middleware, but it employs the JDBC separator developed by the Bank of Communications of China to realize the read/write separation—the DML and the updating-type storage process are transmitted to the DB2 member of the primary center, while the DQL and the query-type storage process are transmitted to the DB2 member of the secondary center;
The DB layer is based on the IBM GDPC architecture, but it is a bran-new active-active disaster backup architecture suitable for online transaction processing formed through sufficient tests and optimizations based on the IBM GDPC architecture, rather than the standard GDPC architecture. The active-active can only be realized by combining such architecture with the read/write separation technology.

The architecture has the following characteristics:

The production center has two DB2 members and two cluster caching facilities (CF), primary and secondary CFs. The CF is also called as PowerHA pureScale, which is a component of the DB2 pureScale cluster for coordinating the accesses to the shared data by the DB2 members in the cluster, and for ensuring the data consistency. The component may be divided into three modules: Group Bufferpool, Global lock manager and Shared Communication Area. And the component is implemented by three processes: ca-server, ca-mgmnt-lwd and ca-wdog. The backup center has one DB2 member and one cold backup CF, which constitute a DB data sharing group. This architecture mainly differs from the IBM GDPC architecture in the following three distinctions:
The primary and secondary CFs are both placed at the production center, which brings far better performance to a DML and the updating-type storage process only operated at the production center than the IBM GDPC architecture, and there is almost no influence on the query dynamic SQL and the query-type storage process only operated at the secondary center.
The numbers of hosts for the DB2 members and the CFs of the production center and the backup center need not to be consistent with each other, so that the extension is more flexible than the IBM GDPC architecture.
The backup center has a cold backup CF as a backup for the secondary CF of the production center, and it is only used at the time of a planned switching to ensure that the service will not be interrupted during the switching.

When an unplanned switching happens, the DB2 member of the backup center plays the roles of both the DB and the CF, and the role transition is performed by means of scripts, thus the flexible role transition breaks the limitation to the IBM GDPC software product. The information acquiring unit 502 may be configured to capture the database access related information of the online transaction from the APP server.

The access information recognizing unit 503 is configured to automatically recognize update statements and query statements according to SQL statements in the database access related information and a type of a storage process.

As illustrated in FIG. 6, the access information recognizing unit 503 comprises an access information classifying module 601 and a policy table generating module 602.

The access information classifying module 601 automatically recognizes the update statements and the query statements according to the SQL statements in the database access related information and the type of the storage process. The policy table generating module 602 generates a separating policy table of the storage process and a separating policy table of the dynamic SQL. The separating policy table of the storage process comprises updating-type storage process names, and the separating policy table of the dynamic SQL sets the initial word “select” of the SQL statement as a keyword.

As illustrated in FIG. 2, for the separating policy table of the storage process, if the updating-type storage process names include PMP_SYS_JOURNAL, UPDATE, SAVE, ADD, UPP or UPD statement, the database access related information is an update statement, otherwise it is a query statement.

As illustrated in FIG. 3, for the separating policy table of the dynamic SQL, if the initial word is “select” as the keyword, the database access related information is a query statement, otherwise it is an update statement.

The statement separating unit 504 directs the update statements and the query statements to database servers of the primary center and the backup center for operation, respectively, thereby routing the update statements and the query statements to the primary center and the backup center for operation, respectively.

The technology for realizing read/write separation in the embodiments of the present invention takes the principle of not to modify the application, and the read/write separation is realized in the JDBC layer, including the following two parts:
A set of programs for the standard JDBC Driver interface: these programs in fact send the request to the JDBC Driver Controller (as illustrated in FIG. 4), rather than directly sending the request to the database. When a certain DB node is faulted, the transaction is automatically transferred to a DB node in normal state through an Auto Client Rerouter (ACR), so as to ensure the sustainability of the transaction.
A JDBC Driver Controller: it is an always running process, and also a control switch for the read/write separation of the transaction. It receives an SQL request from the JDBC Driver interface, judges the SQL content, forwards the request for SQL for updating and storage process for updating to the DB2 member of the primary center, and forwards the request for SQL for query and storage process for query to the DB2 member of the secondary center.

By the embodiments of the present invention, the query statements (the query statements are almost not influenced by the distance delay; the transaction response time of the backup center falls within an acceptable range by routing the query statements to the backup center in the same city for operation; meanwhile, a database lock occupied by the query statements is a shared lock, and it also does not influence the performance of the local transaction) is routed to the backup center to realize an open system ultra-far-distance (70 km) bicentric transaction processing, thereby breaking the limitation of the 30 km distance of the IBM GDPC and ORACLE Rac technologies, improving the processing capacity and usability of the production system, extending the selection range of the active-active system, sufficiently utilizing the resources of the remote center, and improving the high usability of the open system. The present invention is suitable for not only commercial banks, but also industries concerning large-scale online transaction processing, such as securities, futures, civil aviation, railway, etc.

A person skilled in the art shall appreciate that the embodiments of the present invention may be provided as a method, a system, or a computer program product. Thus the present invention may adopt the form of complete hardware embodiment, complete software embodiment, or software and hardware combined embodiment. In addition, the present invention may adopt the form of a computer program product which is implementable in one or more computer readable storage mediums (including, but not limited to, magnetic disk memory, CD-ROM, optical memory, etc.) containing computer readable program codes therein.

The present invention is described with reference to the flowcharts and/or block diagrams of the method, device (system) and computer program product according to the embodiments of the present invention. It shall be appreciated that each flow and/or block in the flowchart and/or block diagram, and the combinations of the flows and/or blocks in the flowchart and/or block diagram can be implemented through computer program instructions. The computer program instructions may be provided to a general computer, a dedicated computer, an embedded processor or a processor of other programmable data processing device, to form a machine so that the instructions, which are executed through the computer or the processor of other programmable data processing device, generate means for realizing the functions specified in one or more flows in the flowchart and one or more blocks in the block diagram.

The computer program instructions may also be stored in a computer readable memory which is capable of guiding the computer or other programmable data processing device to work in a specific mode, so that the instructions stored in the computer readable memory generate a product including instructing means for realizing the functions specified in one or more flows in the flowchart and one or more blocks in the block diagram.

The computer program instructions may also be loaded to the computer or other programmable data processing device, so that a series of operation steps can be performed in the computer or other programmable device to generate a processing realized by the computer, thus the instructions executed in the computer or other programmable device provide the steps for realizing the functions specified in one or more flows in the flowchart and one or more blocks in the block diagram.

The principle and embodiments of the present invention are described through the specific embodiments, but the above descriptions of the embodiments just promote the understanding of the method and the core idea of the present invention. Meanwhile, a person skilled in the art can modify the embodiments and the application range according to the idea of the present invention. In summary, the content of the Specification shall not be understood as limitations to the present invention.

1. An open database-based far-distance bicentric online processing method, comprising:
capturing a database access related information of an online transaction from an APP server;
automatically recognizing update statements and query statements according to SQL statements in the database access related information and a type of a storage process; and
directing the update statements and the query statements to database servers of a primary center and a backup center respectively for operation.

2. The method according to claim 1, wherein before automatically recognizing the update statements and the query statements according to the SQL statements in the database access related information and the type of the storage process, the method further comprising: constituting a far-distance bicentric four-layered architecture F5->Web->APP->DB.

3. The method according to claim 2, wherein the step of automatically recognizing the update statements and the query statements according to the SQL statements in the database access related information and the type of the storage process comprises:
dividing the database access related information into the update statements and the query statements according to the SQL statements and the storage process; and
generating a separating policy table of the storage process and a separating policy table of dynamic SQL, wherein the separating policy table of the storage process comprises updating-type storage process names, and the separating policy table of the dynamic SQL sets an initial word “select” of the SQL statement as a keyword.

4. The method according to claim 3, wherein for the separating policy table of the storage process, if the updating-type storage process names include updated keyword statement or update statement contains a list of the stored procedure name, the database access related information is an update statement, otherwise it is a query statement.

5. The method according to claim 3, wherein for the separating policy table of the dynamic SQL, if the initial word is “select” as the keyword, the database access related information is a query statement, otherwise it is an update statement.

6. An open database-based far-distance bicentric online processing system, comprising:
an information acquiring unit configured to capture a database access related information of an online transaction from an APP server;
an access information recognizing unit configured to automatically recognize update statements and query statements according to SQL statements in the database access related information and a type of a storage process; and
a statement separating unit configured to direct the update statements and the query statements to database servers of a primary center and a backup center respectively for operation.

7. The system according to claim 6, further comprising:
an architecture constructing unit configured to constitute a far-distance bicentric four-layered architecture F5->Web->APP->DB.

8. The system according to claim 7, wherein the access information recognizing unit comprises:
an access information classifying module configured to automatically recognize the update statements and the query statements according to the SQL statements in the database access related information and the type of the storage process; and
a policy table generating module configured to generate a separating policy table of the storage process and a separating policy table of dynamic SQL, wherein the separating policy table of the storage process comprises updating-type storage process names, and the separating policy table of the dynamic SQL sets an initial word “select” of the SQL statement as a keyword.

9. The system according to claim 8, wherein for the separating policy table of the storage process, if the updating-type storage process names include updated keyword statement or update statement contains a list of the stored procedure name, the database access related information is an update statement, otherwise it is a query statement.

10. The system according to claim 8, wherein for the separating policy table of the dynamic SQL, if the initial word is “select” as the keyword, the database access related information is a query statement, otherwise it is an update statement.
